(19) United States
(12) Patent Application Publication
(10) Pub. No.: US 2007/0075980 A1
(43) Pub. Date: Apr. 5, 2007

(54) DISPLAY APPARATUS ENABLING TO DISPLAY MULTIPLE MENUS AND TOUCH-BASED DISPLAY METHOD THEREFOR

(76) Inventors: Kuan-Hong Hsieh, Shenzhen (CN); Han-Che Wang, Shenzhen (CN); Xiao-Guang Li, Shenzhen (CN); Wen-Chuan Lian, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/309,098

(22) Filed: Jun. 22, 2006

(30) Foreign Application Priority Data
Sep. 21, 2005 (CN) 200510037469.3

(51) Int. Cl. G09G 5/00

(52) U.S. Cl. 345/173

(57) ABSTRACT

A touch-based display apparatus and touch-based display method therefor is provided. The touch-based display method for the display apparatus includes the steps of: providing a display apparatus including a screen and a frame connecting to the screen, the screen having a plurality of menu regions and the frame having a plurality of touch strips each mapped to one of the menu regions; receiving and processing any sensing signal from one of the touch strips; displaying an associated menu in the menu region corresponding to the signaled touch strip; hiding at least one of the menu options displayed in the menu region and replacing at least one of the displayed menu options by another hidden menu option when receiving a plurality of new sensing signals from the signaled touch strip; and performing a function indicated by a selected menu option when receiving a sensing signal from the signaled touch strip.

### TECHNICAL FIELD

The present invention relates to a display apparatus and display method therefor, and particularly to a display apparatus enabling to display multiple menus and a related touch-based display method for the display apparatus.

### GENERAL BACKGROUND

Generally, a display apparatus is a device to visually output information or graphics on a screen. It is widely and increasingly used in electronic devices. A first conventional display apparatus includes a screen to display data (i.e., an image) thereon, and a frame to support the screen. The frame is further disposed a plurality of mechanical function buttons thereon to actuate any desired function. The more functions the display apparatus has, the more mechanical function buttons the frame is disposed thereon. Therefore, the frame should be designed as large as possible to hold the mechanical function buttons. As a result, a volume of the display apparatus as a whole becomes larger, and an overall appearance of the whole display apparatus looks untidy.

A second conventional display apparatus adopts a touch screen instead of mechanical buttons. The touch screen using graphical user interface (GUI) displays on the display screen thereof buttons, allowing a user to touch by finger or the like for making a selection. However, by directly touching the display screen, the touch screen thereupon is easily scratched or damaged.

Therefore, there is a need for an improved display apparatus and touch-based display method therefore that can overcome the above-mentioned problems.

### SUMMARY

A touch-based display apparatus is provided. The display apparatus is capable of displaying multiple menus. The display apparatus includes a screen and a frame. The screen has a plurality of menu regions. Each menu region displays a menu therein. The menu further includes a plurality of menu options. The frame connects to the screen and has a plurality of touch strips thereof. Each touch strip corresponds to one of the menu region, and allows to select a desired menu option to perform an associated function therewith.

A touch-based method enabling a display apparatus to display multiple menus is also provided. The method includes the steps of: (a) providing a display apparatus having a screen and a frame connecting to the screen, the screen having a plurality of menu regions and the frame having a plurality of touch strips each mapped to one of the menu regions; (b) receiving and processing any sensing signal from one of the touch strips; (c) displaying an associated menu in the menu region corresponding to the signaled touch strip; (d) hiding at least one of the menu options displayed in the menu region and replacing at least one of the displayed menu options by another hidden menu option when receiving a plurality of new sensing signals from the signaled touch strip; and (e) performing a function indicated by a selected menu option when receiving a sensing signal from the signaled touch strip.

Other advantages and novel features will be drawn from the following detailed description with reference to the attached drawings, in which:

### BRIEF DESCRIPTION OF DRAWINGS

FIG. 1 is an exemplary schematic diagram of a touch-based display apparatus enabling to display multiple menus in accordance with a preferred embodiment of the present invention, the display apparatus including a screen and a frame, the frame having a plurality of touch strips thereof;

FIG. 2 is a block diagram representing a hardware infrastructure of a sensing signal processing circuit for a touch sensitive unit beneath the touch strips of FIG. 1 with the signal processing circuit connecting to a processing unit;

FIGS. 3A-3D illustrate a series of menus displayed in different menu regions of the screen of FIG. 1 in accordance with a preferred embodiment of the present invention, each menu region corresponding to a touch strip of FIG. 1; and

FIG. 4 is a flowchart of a preferred touch-based method for enabling a display apparatus of FIG. 1 to display multiple menus in accordance with a preferred embodiment of the present invention.

### DETAILED DESCRIPTION

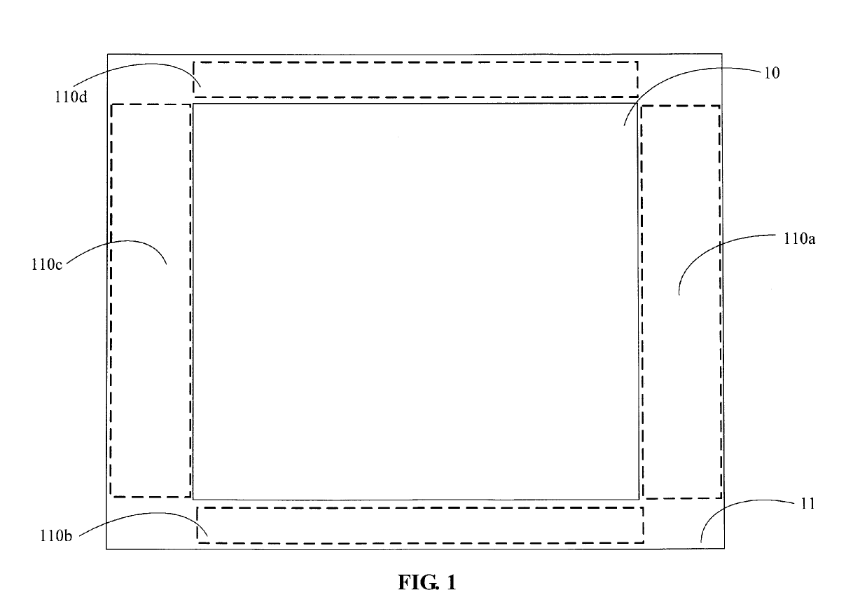

FIG. 1 is an exemplary schematic diagram of a touch-based display apparatus enabling to display multiple menus in accordance with a preferred embodiment of the present invention. The display apparatus includes a screen 10 and a frame 11. The screen 10 has a plurality of menu regions each for displaying a menu therein. The menu contains a number of menu options and a part of the menu options may be hidden due to the limited space of the screen 10. The frame 11 includes a plurality of touch strips (symbolically indicated by 110a, 110b, 110c, and 110d) thereon selectable by contact to perform a particular function associated with the menu regions. For example, a contact on any one of the touch strips initiates a menu to be displayed on one of the menu regions. After initiating the menu, a further contact on the touch strip selects a desired menu option of the displayed menu. That is, a stroke on the touch strip hides the displayed but undesired menu options out of the menu region until the hidden but desired menu option appears in the menu region. When the desired menu option appears, a further touch on a corresponding location of the touch strip performs the function associated with the menu option such as, for example, expanding a sub-menu of the menu option, executing a particular operation indicated by the menu option, etc. In addition, the sub-menu can be displayed in the same menu region as the menu option, or in other menu regions different from the menu option.

In order to provide a friendly and easy user interface, each touch strip is designed to correspond to one of the menu regions parallel to it. Preferably, a length of each touch strip is designed to correspond to a length of a side of the screen 10. Furthermore, each touch strip has a plurality of touch sensitive units (not shown) beneath thereof. Each touch sensitive unit is constructed to essentially map to a menu option of the menus. That is, each touch sensitive unit is designed to perform a function associated with the menu option. Moreover, each touch sensitive unit includes a sensing signal processing circuit 112 (described in more detail below) for generating sensing signals to perform the function associated with the menu option in response to a contact on a corresponding location of the touch strip. Each touch sensitive unit beneath the touch strip is further designated a coordinate for identifying itself.

The display apparatus further includes a processing unit 12 (not shown). The processing unit 12 receives and processes the sensing signals from the touch sensitive units beneath the touch strips according to associated coordinates therewith, and performs corresponding functions. For example, in response to a single sensing signal from the touch strips, the processing unit 12 processes the sensing signal, and initiates and displays the menu last displayed thereon in a corresponding menu region associated with the signaled touch strip; in response to a plurality of sensing signals from the predetermined touch strip while the corresponding menu is in display, the processing unit 12 hides at least one of the menu options displayed in the menu region and replaces at least one of the displayed menu options by one of the hidden menu options; in response to a sensing signal from the predetermined touch strip, the processing unit 12 performs the function indicated by the selected menu option in the menu region. In addition, when the menu option has a sub-menu, the processing unit 12 further expands the sub-menu of the menu option in the same menu region as the menu option or in other menu regions different from the menu option.

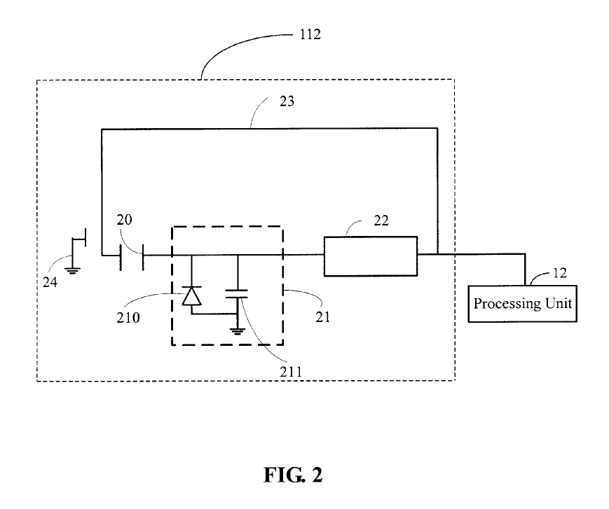

FIG. 2 is a block diagram representing a hardware infrastructure of a sensing signal processing circuit for the touch sensitive unit beneath the touch strips of FIG. 1 with the signal processing circuit connecting to the processing unit. The sensing signal processing circuit 112 mainly includes an antenna 20, a clamping circuit 21, a detector 22, a feedback line 23, and a grounding line 24. The antenna 20 is connected to the clamping circuit 21. The clamping circuit 21 is connected to an input end of the detector 22. An output end of the detector 22 is respectively connected to the processing unit 12 and one end of the feedback line 23. The feedback line 23 forms a positive feedback circuit with the antenna 21. The grounding line 24, namely a space between two adjacent touch sensitive units, is for spacing the touch sensitive units therebetween.

The human body is itself electrically charged with noise and static signals. Therefore, when a user contacts the touch strips, the noise and static signals of the user flow through the antenna 20. The antenna 20 transmits the noise and static signals to the clamping circuit 21. However, the static electrical signals may cause interference to the noise, and may even fry the detector 22. In addition, a strong noise may adversely influence a resulting sensing signal for the processing unit 12; that is, the sensitivity of the touch sensitive unit may be diminished. Accordingly, the clamping circuit 21 is for eliminating the static signals and for reducing the noise, thus improving the sensitivity accuracy of the touch sensitive unit. The clamping circuit 21 includes a diode 210, and a capacitor 211. The anode of the diode 210 is connected to the antenna 20, while the cathode is connected to ground. Upon receiving the noise and static signals, the diode 210 filters out the static signals to ground so as to avoid frying the detector 22, and reducing the noise influencing to the capacitor 211. The capacitor 211 further leaks a portion of the reduced noise to ground. Thus the reduced noise is further weakened, thereby obtaining a more accurate sensitivity. The detector 22 has a high input impedance, so as to easily detect the reduced and weakened noise received from the input end of the detector 22. The detector 22 then converts the further reduced and weakened noise into digital signals, namely the sensing signals, and transmits the digital signals through the output end of the detector 22 to the processing unit 12 to perform corresponding controls. Furthermore, because the feedback line 23 forms a positive feedback circuit with the antenna 20, the noise generated as the user touches the edge of the touch sensitive unit is filtered, thereby further improving the sensitivity accuracy of the touch sensitive unit.

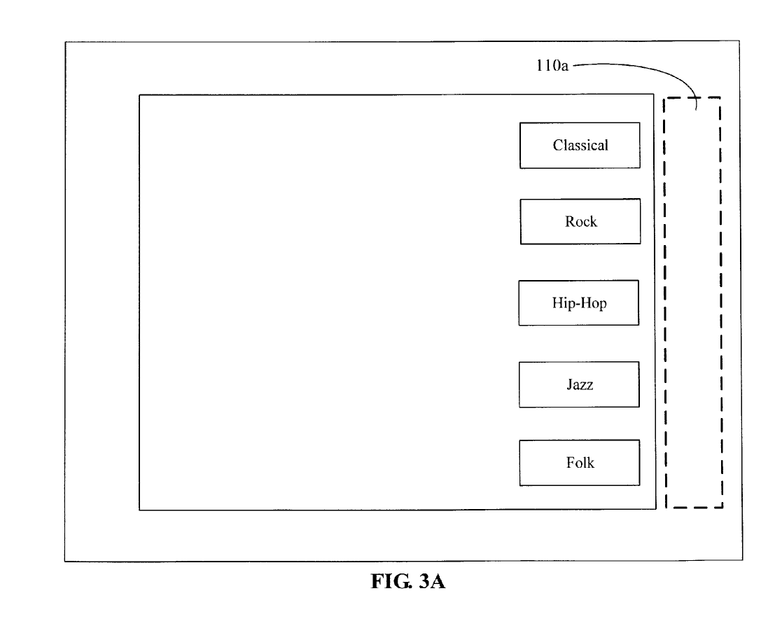

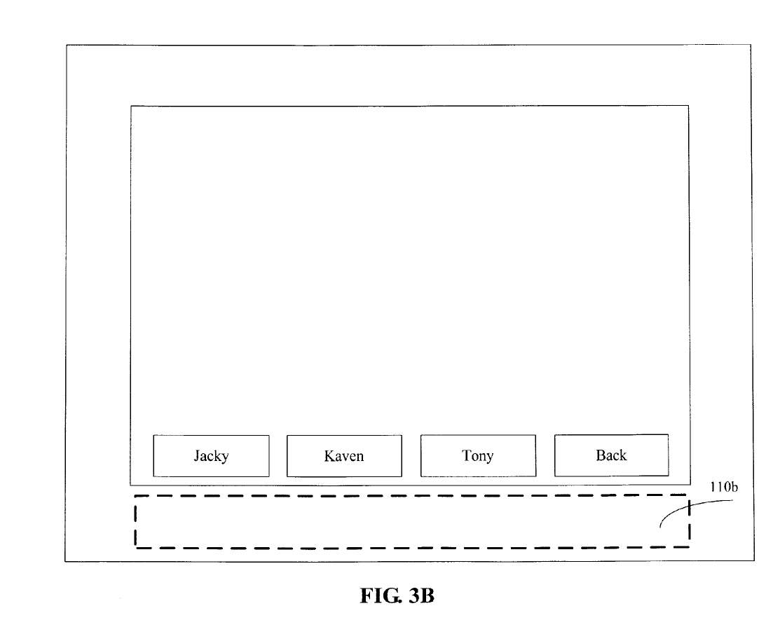

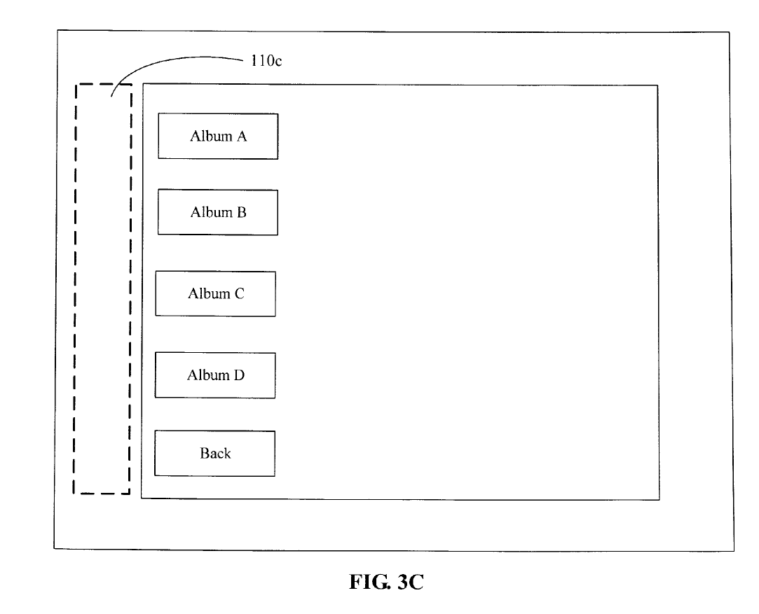

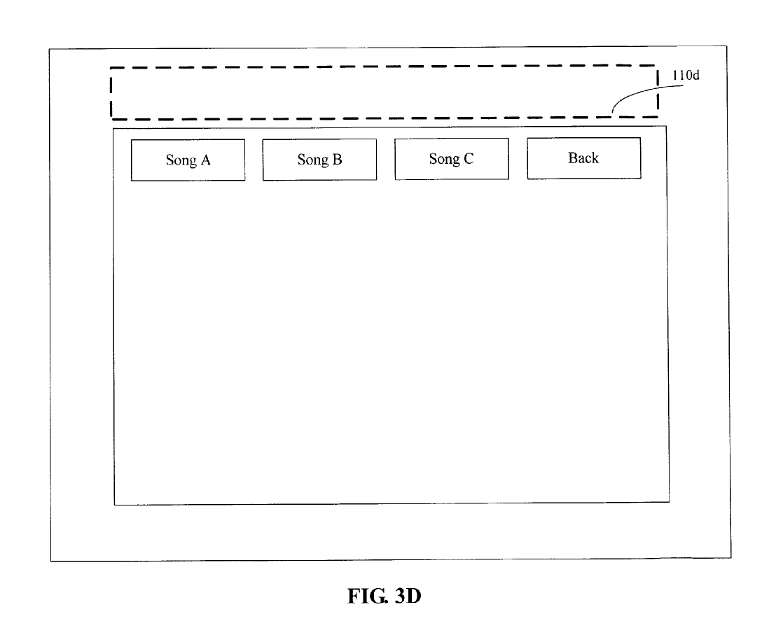

FIGS. 3A-3D illustrate a series of menus displayed in different menu regions of the screen of FIG. 1 in accordance with a preferred embodiment of the present invention, each menu region corresponding to a touch strip of FIG. 1. As described above, a sub-menu of a selected menu option can be displayed in the same menu region as the menu option or in other menu regions different from the menu option. For simplicity, in this embodiment, the later manner is adopted and described in detail below. In addition, contents of the menu options employ information related music as an example, and only four menus are illustrated therein. However, either the content of the menu options or the number of the menus are not to be construed as being limited thereto.

Therefore, each menu region corresponding to one touch strip displays one part of the information. For example, referring to FIGS. 3A-3D, a first menu region corresponding to the touch strip 110a displays a first menu containing the information related music styles (e.g., Classical, Rock, Hip-Hop, Jazz, Folk, etc.), a second menu region corresponding to the touch strip 110b displays a second menu containing the information related music singers (e.g., tacky, Kaven, Tony, etc.), a third menu region corresponding to the touch strip 110c displays a third menu containing the information related music albums (e.g., Album A, Album B, Album C, Album D, etc.), and a fourth menu region corresponding to the touch strip 110d displays a fourth menu containing the information related music names (e.g., Song A, Song B, Song C, etc.). In other words, the second menu region displays the sub-menu of the menu option in the first menu region, the third menu region displays the sub-menu of the menu option in the second menu region, and the fourth menu region displays the sub-menu of the menu option in the third menu region. Furthermore, the menus except the first menu each have a “Back” menu option displayed in a constant location in the menu regions for easily returning to a former menu.

Accordingly, because touch strips are used instead of function buttons for performing functions, the frame 11 can retain its neatness, regardless of how many functions the display apparatus has. Furthermore, since the surface areas of the touch sensitive strips can be designed in smaller sizes, the frame 11 of the display apparatus thereupon can be designed in a narrower size, whereas the screen 10 thereof can be designed in a larger size, thereby the display apparatus may not only obtain a neater appearance but may also posses a larger screen for display. Moreover, due to the multidimensional touch strips and dynamic menus of the display apparatus, the user can easily select a desired menu option to perform the function associated therewith.

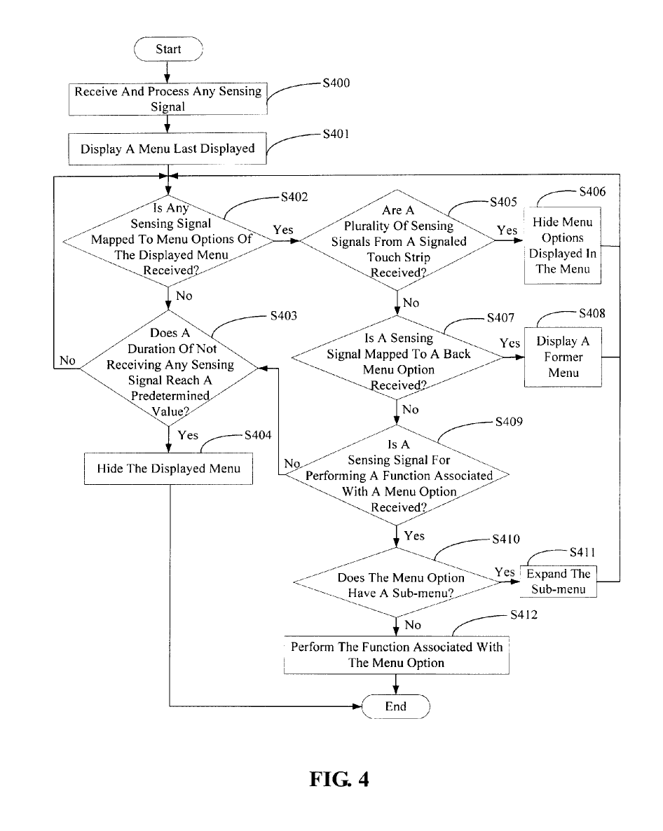

FIG. 4 is a flowchart of a preferred touch-based method for enabling a display apparatus of FIG. 1 to display multiple menus in accordance with a preferred embodiment of the present invention. In step S400, the processing unit 12 receives and processes any sensing signal from the touch sensitive units beneath the touch strips. In step S401, the processing unit 12 initiates and displays the menu last displayed thereon in a corresponding menu region associated with the signaled touch strip. In step S402, the processing unit 12 determines whether it receives any sensing signal mapped to the menu options of the displayed menu. If received, the procedure goes to step S405 described below. If not, in step S403, the processing unit 12 determines whether the duration of not receiving any sensing signal mapped to the menu options of the displayed menu reaches the predetermined value. If the duration reaches the predetermined value, in step S404, the processing unit 12 hides the menu displayed on the menu region, and the procedure is finished. If the duration does not reach the predetermined value, the procedure returns to step S402.

In step S405, the processing unit 12 determines whether it further receives a plurality of sensing signals from the predetermined touch strip. If received, in step S406, the processing unit 12 hides at least one of the menu options displayed in the menu and replaces at least one of the displayed menu options by another hidden menu option, and the procedure returns to step S402. If not, in step S407, the processing unit 12 determines whether it receives the sensing signal mapped to the “Back” menu option. If received, in step S408, the processing unit 12 displays a former menu on a corresponding menu region, and the procedure returns to step S402. If not, in step S409, the processing unit 12 determines whether it receives the sensing signal for performing the function associated with the menu options except the “Back” menu option. If received, in step S410, the processing unit 12 determines whether the selected menu option has a sub-menu. If the selected menu option has a sub-menu, in step S411, the processing unit 12 expands the sub-menu of the selected menu option in an associated menu region, and the procedure returns to step S402. If the selected menu option doesn't have a sub-menu, in step S412, the processing unit 12 performs the function associated with the menu option, and the procedure is finished.

Although the present invention has been specifically described on the basis of the preferred embodiment and preferred method thereof, the invention is not to be construed as being limited thereto. Various changes or modifications may be made to the embodiment and method without departing from the scope and spirit of the invention.

What is claimed is:

1. A touch-based display apparatus enabling to display multiple menus, the display apparatus comprising:
a screen having a plurality of menu regions, each menu region displaying a menu therein, wherein the menu has a plurality of menu options; and
a frame connecting to the screen and having a plurality of touch strips thereof, each touch strip being selective to a desired menu option to perform an associated function therewith, and each touch strip corresponding to a menu region.

2. The apparatus according to claim 1, wherein each touch strip comprises a plurality of touch sensitive units each mapped to a menu option.

3. The apparatus according to claim 2, wherein each touch sensitive unit further comprises a sensing signal processing circuit for generating sensing signals in response to contact, and each touch sensitive unit is designated a coordinate for identification.

4. The apparatus according to claim 3, further comprising a processing unit for processing the sensing signals and performing corresponding functions associated with the menu options.

5. The apparatus according to claim 4, wherein the processing unit initiates and displays menu options last displayed on the menu regions in response to the contact on the touch strips.

6. The apparatus according to claim 5, wherein the processing unit hides at least one of the menu options displayed in the menu region and replaces at least one of the displayed menu options by another hidden menu option in response to a stroke operation on the touch strips.

7. The apparatus according to claim 6, wherein the processing unit expands a sub-menu of a selected menu option in response to a touch operation on the touch strips.

8. The apparatus according to claim 7, wherein the sub-menu of the selected menu option is expanded in a different menu region from the selected menu option.

9. The apparatus according to claim 8, wherein the sub-menu of the selected menu option has a particular menu option indicating a function of returning to a former menu.

10. The apparatus according to claim 9, wherein a location of the particular menu option is constant.

11. The apparatus according to claim 10, wherein lengths of the touch strips correspond to a length of a side of the screen.

12. A touch-based method enabling a display apparatus to display multiple menus, the method comprising the steps of:
providing a display apparatus having a screen and a frame connecting to the screen, the screen having a plurality of menu regions and the frame having a plurality of touch strips each mapped to one of the menu regions;
receiving and processing any sensing signal from one of the touch strips; displaying an associated menu in the menu region corresponding to the signaled touch strip;
hiding at least one of the menu options displayed in the menu region and replacing at least one of the displayed menu options by another hidden menu option when receiving a plurality of sensing signals from the signaled touch strip; and
performing a function indicated by a selected menu option when receiving a sensing signal from the signaled touch strip.

13. The touch-based method according to claim 12, further comprising the step of:
hiding the displayed menu when a duration of not receiving any sensing signal from the predetermined touch strip reaches a predetermined value.

14. The touch-based method according to claim 13, wherein the step of performing a function indicated by a selected menu option when receiving a sensing signal from the signaled touch strip further comprises the step of:
expanding a sub-menu of the selected menu option if the selected menu option has the sub-menu.

15. The touch-based method according to claim 14, wherein the sub-menu is displayed in a different menu region from the selected menu option.

16. The touch-based method according to claim 13, wherein the step of performing a function indicated by a selected menu option when receiving a sensing signal from the signaled touch strip further comprises the step of:
displaying a former menu when the selected menu option indicates a function of returning to the former menu.

17. The touch-based method according to claim 16, wherein a location of the menu option indicating the function of returning to the former menu is constant.
